(19) United States
(12) Patent Application Publication
(10) Pub. No.: US 2005/0211664 A1
(43) Pub. Date: Sep. 29, 2005

(54) Method of forming optical waveguides in a semiconductor substrate

(75) Inventors: Anisul Khan, Santa Clara, CA (US); Ajay Kumar, Cupertino, CA (US)

Correspondence Address: MOSER, PATTERSON & SHERIDAN, LLP;APPLIED MATERIALS INC, 595 SHREWSBURY AVE, SUITE 100, SHREWSBURY, NJ, 07702, US

(73) Assignee: Applied Materials, Inc.

(21) Appl. No.: 11/130,553

(22) Filed: May 16, 2005

Related U.S. Application Data
(63) Continuation-in-part of application No. 09/957,395, filed on Sep. 19, 2001.

(51) Int. Cl. B29D 11/00

(52) U.S. Cl. 216/24; 216/41; 216/37

(57) ABSTRACT

Embodiments of optical waveguides and method for their fabrication are provided herein. In one embodiment, a method of making an optical waveguide, includes the steps of providing a substrate comprising a semiconductor layer disposed on a first insulating layer. A hard mask is formed on the semiconductor layer. An opening is then etched in the semiconductor layer to expose a portion of the first insulating layer using the hard mask. A core material is deposited on the first insulating layer to fill the opening. The core material is then planarized and the hard mask removed. A top cladding layer is finally deposited over the core material.

### CROSS-REFERENCE TO RELATED APPLICATIONS

This application is a continuation-in-part of co-pending U.S. patent application Ser. No. 09/957,395, filed Sep. 19, 2001, which is herein incorporated by reference in its entirety.

### BACKGROUND OF THE INVENTION

1. Field of the Invention

This invention relates to a method of making optical waveguides using conventional semiconductor techniques. More particularly, this invention is directed to silicon-based optical waveguides and methods manufacture in or on a silicon substrate using well established, semiconductor processes and equipment.

2. Description of the Related Art

A method of making silicon-based waveguides is known comprising depositing a first or bottom cladding layer on a silicon substrate, depositing a layer of core material, such as silicon oxide, patterning and etching the core material to remove excess core material, and depositing a second or top cladding layer over the core material.

Such a waveguide is shown in FIG. 1, wherein a silicon substrate 1 has a first cladding layer 2 formed thereover. A thick core layer 6 is deposited over the first cladding layer 2. The core layer 6 is then masked, and the mask is patterned. The core layer 6 is then etched to remove excess material so that only the guide core 6 remains. A second cladding layer 8 is deposited over the core layer 6. This waveguide method requires several deposition, mask and etch steps.

In addition, the silicon oxide core material is a thick layer, e.g., about 15 microns thick. Because of this thickness, the core layer 6 on the silicon substrate is highly stressed. Furthermore, when such a thick oxide layer is etched to form the core, the sidewalls become striated and rough. However, smooth sidewalls and upper surfaces of all of the layers of a waveguide are required for optical devices.

Thus, it would be highly desirable to be able to form optical waveguides that do not have rough or striated surfaces that must be smoothed in a separate process, thereby increasing the cost of such devices.

### SUMMARY OF THE INVENTION

An optical waveguide is made in a suitable substrate using standard semiconductor techniques by first etching an opening in the substrate. A first cladding layer is deposited in the opening conformally, the opening is filled with a core material, the excess core material is removed as by chemical mechanical polishing, which provides a smooth surface, and a second cladding layer is deposited thereover. Any excess second cladding layer can also be removed by chemical mechanical polishing.

In a particular embodiment, a silicon substrate having layers of silicon oxide and silicon nitride thereon, is masked and etched to form a hard mask, and the silicon is etched to form an opening therein. A first cladding layer is deposited in the opening conformally and the opening is filled with core material. Excess core material and the silicon oxide layer are removed by chemical mechanical polishing, hereinafter CMP, which provides a smooth, polished surface, the silicon nitride layer is stripped away and a top or second cladding layer is deposited thereover.

In another embodiment, a method of making an optical waveguide, includes the steps of providing a substrate comprising a semiconductor layer disposed on a first insulating layer. A hard mask is formed on the semiconductor layer. An opening is then etched in the semiconductor layer to expose a portion of the first insulating layer using the hard mask. A core material is deposited on the first insulating layer to fill the opening. The core material is then planarized and the hard mask removed. A top cladding layer is finally deposited over the core material.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a cross sectional view of a prior art waveguide.

FIG. 2 illustrates one embodiment of an optical waveguide in accordance with the invention.

FIGS. 3A to 3F illustrate the method steps used to make another embodiment of an optical waveguide in accordance with the invention.

FIGS. 4A to 4F illustrate the steps used to make another embodiment of an optical waveguide in accordance with the invention.

FIGS. 5A to 5H illustrate the steps used to make another embodiment of an optical waveguide in accordance with the invention.

FIGS. 6A to 6H illustrate the steps used to make another embodiment of an optical waveguide in accordance with the invention.

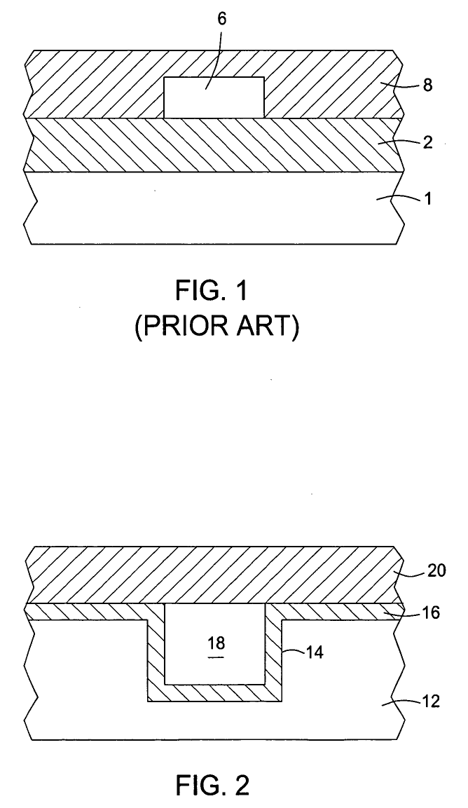

### DETAILED DESCRIPTION

The present waveguides are readily made using standard semiconductor materials, processes and processing equipment. For example, the substrates can be made of silicon, but other materials such as silicon-germanium, gallium arsenide, indium gallium arsenide, indium phosphide, and the like can also be used. What is important in forming a waveguide is that the cladding layers and the core layer each have a different refractive index. Moreover, the present waveguides may be formed on the same substrate as other devices that together form an integrated circuit.

The present fabrication methods will be illustratively described using silicon or a silicon-containing material as the substrate, such as glasses that can be differently doped. The two cladding layers and the core material can be differently doped silicon oxides, so that the refractive index of each of these layers is different. Thus, the cladding and core layers can be made of differently doped silicon oxides, such as glass, phosphosilicate glass (PSG), borophosphosilicate glass (BPSG), quartz, and the like. Moreover, details or steps described in any one of the following embodiments may be utilized in any of the other described embodiments, to the extent not inconsistent with the disclosure.

FIG. 2 illustrates one embodiment of an optical waveguide. The waveguide comprises a silicon-containing substrate 12, an anisotropic opening 14 etched into the substrate 12, a first or bottom cladding layer 16 deposited in the opening, which is then filled with a core material 18. The core material 18 is planarized, such as by using chemical mechanical polishing, hereinafter CMP. The CMP step eliminates the need for etching a thick core layer, and the present core material 18 remains smooth and polished. A second or top cladding layer 20 is deposited over the polished core material 18.

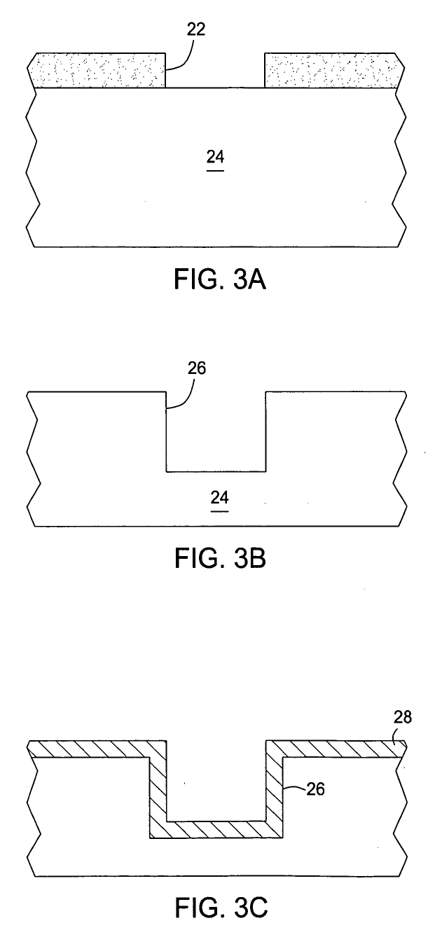

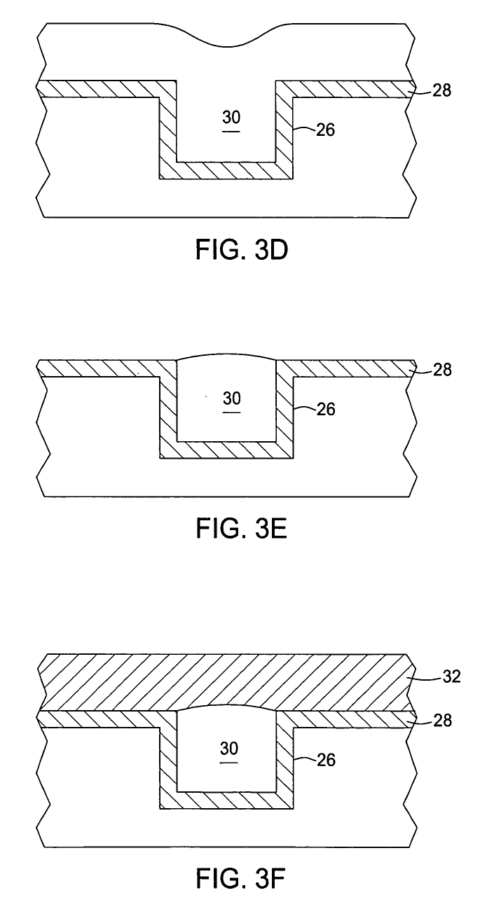

The steps for making the optical waveguide of FIG. 2 are shown in more detail in FIGS. 3a to 3f. A mask layer 22 is deposited over a silicon substrate 24 and is patterned as shown in FIG. 3a. An opening 26 is then etched into the substrate 24 and the mask layer 22 is removed, as shown in FIG. 3b.

A first, or bottom cladding layer 28 is then conformally deposited in the opening 26, as shown in FIG. 3c. A core material 30 is deposited to fill the opening 26, as shown in FIG. 3d. The core material 30 can be a silicon oxide that is doped so as to have a different index of refraction than silicon or the first cladding layer 28. As shown in FIG. 3e, the core material 30 is then planarized, as by CMP.

As shown in FIG. 3f, a top cladding layer 32 is deposited over the planarized core material 30. This top cladding layer 32 can also be a silicon oxide, but one that is differently doped to have a third refractive index.

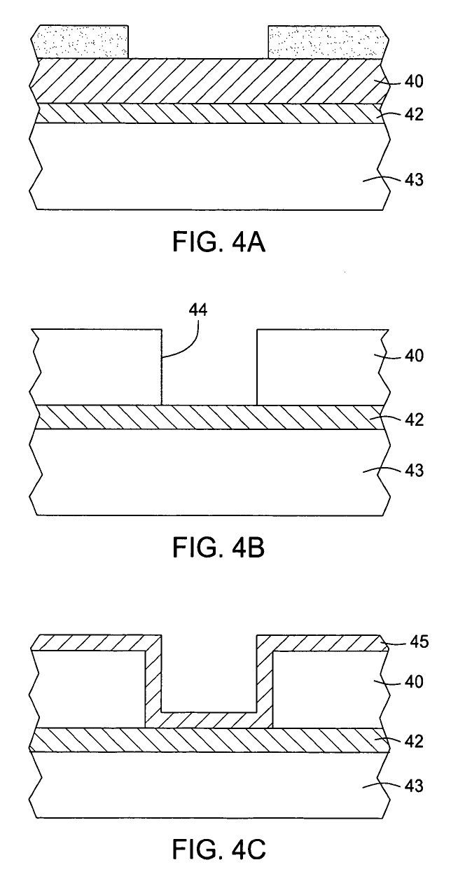

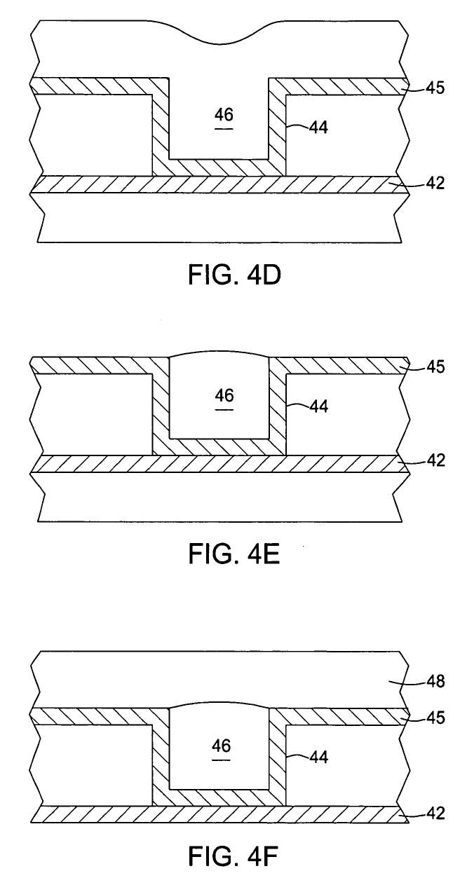

In another embodiment of the present invention, as shown in FIG. 4a, the substrate can be silicon on insulator (SOI), such as a silicon layer 40 formed on two silicon oxide or glass layers 42 and 43, each having a different refractive index.

The silicon layer 40 is masked and etched to form an opening 44 through the silicon layer 40 down to the first glass layer 42, which becomes the first or bottom cladding layer, as shown in FIG. 4b. An additional layer 45 of glass can optionally be deposited conformally in the opening over the first glass layer 42, as shown in FIG. 4c. A core material 46 is then deposited to fill the opening, as shown in FIG. 4d.

The core material 46 is then planarized, as by CMP, as shown in FIG. 4e. A second or top cladding layer 48 is then deposited thereover, as shown in FIG. 4f.

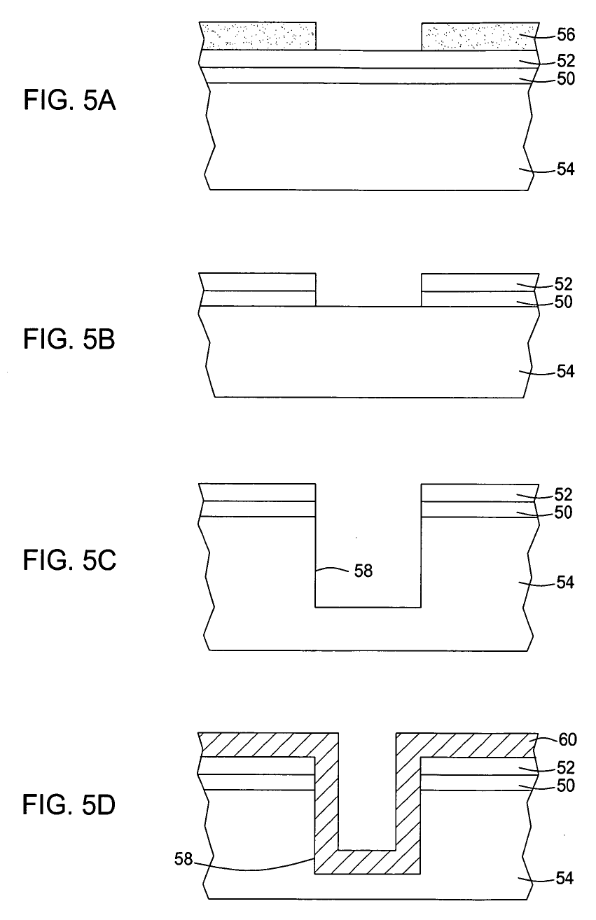

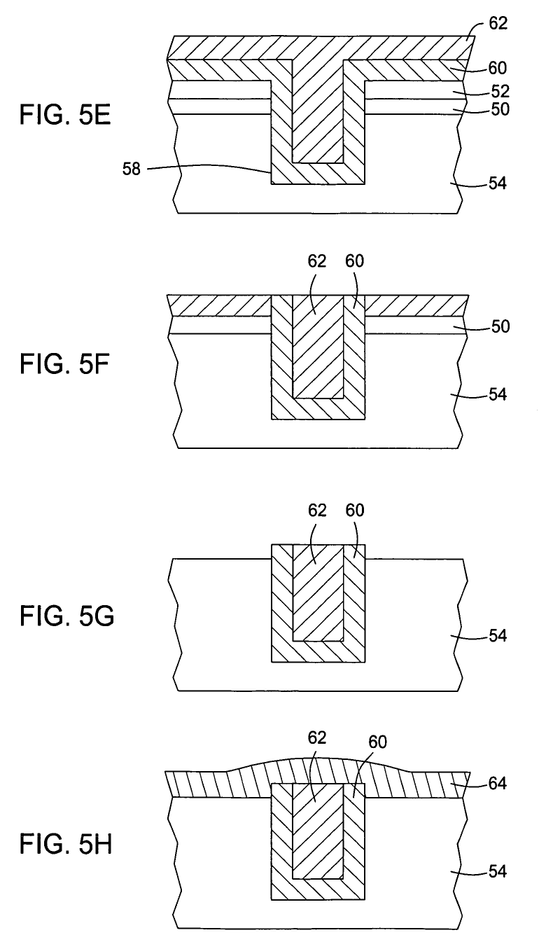

In still another embodiment, described with respect to FIGS. 5a-5h, a layer of silicon oxide 52 over a layer of silicon nitride 50 is deposited on a semiconductor layer 54 (e.g., a silicon substrate). It is contemplated that the semiconductor layer 54 may be a silicon on insulator substrate as described in other embodiments depicted herein. A mask layer 56 is deposited over the silicon oxide layer 52, and is patterned, as shown in FIG. 5a.

An opening is then etched through the silicon oxide layer 52 and the silicon nitride layer 50, forming a hard mask for the semiconductor layer 54. The silicon nitride layer 50 and the silicon oxide layer 52 of the hard mask are then etched down to the semiconductor layer 54 as shown in FIG. 5b. An anisotropic opening 58 is etched in the semiconductor layer 54, as shown in FIG. 5c.

A bottom cladding layer 60 is then conformally deposited in the opening 58, as shown in FIG. 5d. A core material 62 is then deposited to fill the opening 58, as shown in FIG. 5e. The core material 62 and the silicon oxide layer 52 are planarized, as by CMP, as shown in FIG. 5f. The remaining hard mask, e.g., the silicon oxide layer 52 and the silicon nitride layer 50, is stripped away, as shown in FIG. 5g. A second or upper cladding layer 64 is then deposited over the substrate, as shown in FIG. 5h.

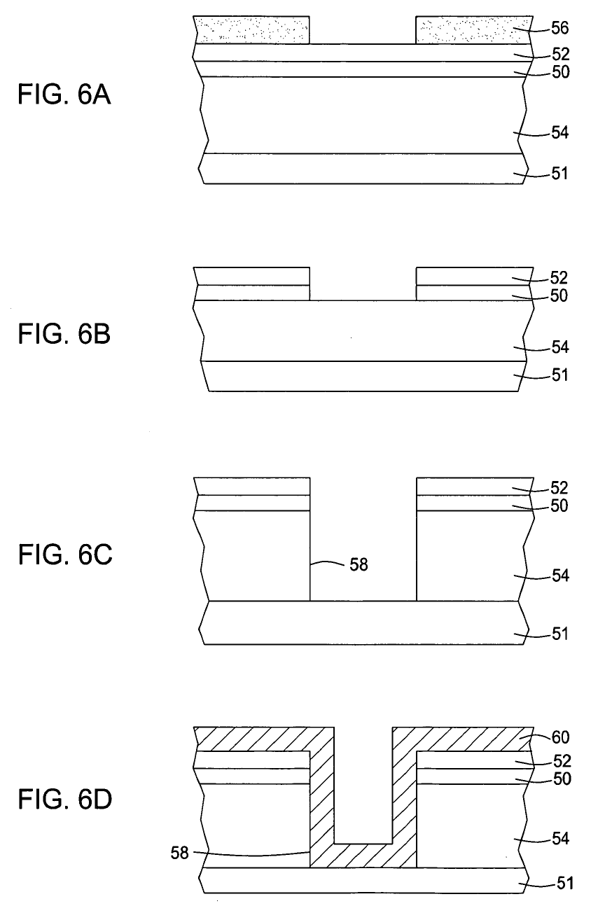

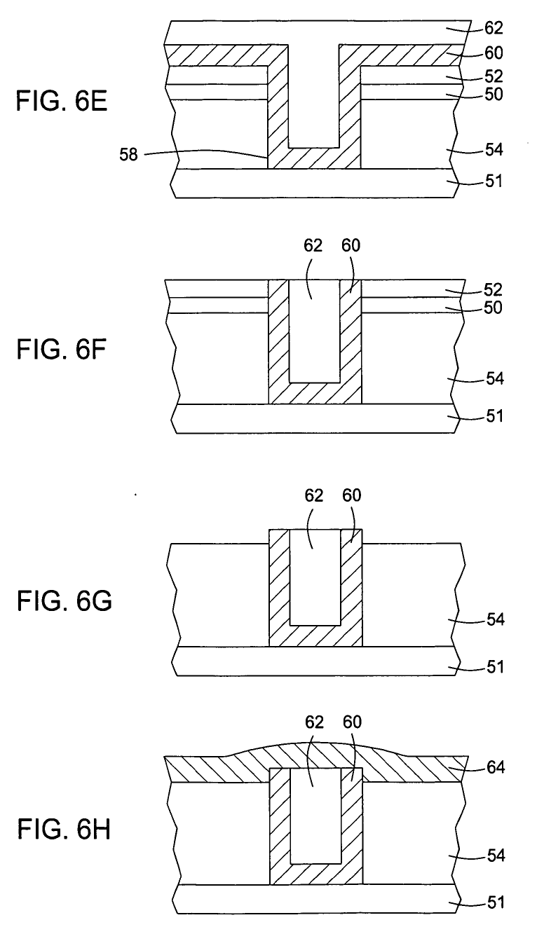

FIGS. 6a through 6h respectively depict the steps of another embodiment of a method of forming an optical wave guide in a semiconductor substrate. As depicted in FIG. 6a, in one embodiment the substrate comprises a semiconductor layer 54 formed over a first insulating layer 51. The semiconductor layer 54 on the first insulating layer of 51 may be part of a semiconductor on insulator substrate, for example, a silicon on insulator substrate as described in above with respect to FIG. 4a. Alternatively, other configurations having a semiconductor layer formed over an insulating layer are also contemplated.

As also shown in FIG. 6a, a silicon nitride layer 50 is deposited on the semiconductor layer 54 and a silicon oxide layer 52 is next deposited over the silicon nitride layer 50. A mask layer 56 is then deposited over the silicon oxide layer 56 and is patterned to form an opening.

The silicon oxide layer 52 and the silicon nitride layer 50 are then patterned by etching down to the semiconductor layer 54 through the opening in the mask layer 56, as depicted in FIG. 6b. The patterned silicon oxide layer 52 and the silicon nitride layer 50 thus form a hard mask on the semiconductor layer 54. An opening 58 is anisotropically etched into the semiconductor layer 54, as shown in FIG. 6c. The opening 58 is formed through the semiconductor layer 54 to expose the first insulating layer 51.

Optionally, a bottom cladding layer 60 may be conformally deposited in the opening 58, as shown in FIG. 6d. A core material 62 is then deposited to fill the opening 58 as shown in FIG. 6e. The core material 62 is in contact with the first insulating layer 51 in embodiments where the optional cladding layer of 60 is not used. The core material 62, optional cladding layer 60, and the silicon oxide layer 52 are planarized, for example by CMP, as shown in FIG. 6f. The remaining hard mask, e.g., the silicon oxide layer 52 and the silicon nitride layer 50, is then stripped away, as shown in FIG. 6g. Finally, a second, or upper cladding layer 64 is then deposited over the silicon layer of 54 as shown in FIG. 6h.

There are several important advantages of the present invention; the waveguides can be made simply and reliably using standard silicon technology. Silicon can be anisotropically etched readily with fluorocarbons, such as CF₄, or known manner. Further, the silicon oxide and glass-type cladding and core layers can be differently doped so the differences in their refractive index can be maximized. By tailoring the refractive index of the core and cladding layers, loss of light by the waveguide is minimized. The silicon substrate can be used to integrate the present waveguides with other devices and components on the substrate. For example, the use of standard semiconductor processes, such as CVD, halogen etchants, CMP and the like means that conventional processes and equipment can be used to build waveguides and other prior art devices, on the same silicon substrate.

Film stresses in the waveguides are greatly reduced because the present optical waveguides are embedded in a silicon wafer, and not deposited in layers which must be patterned and etched. Since the core material is not deposited over a first cladding layer as a thick layer which must be etched, but instead is deposited in an opening made in the silicon substrate, etching of the core layer is not required.

Further, removing excess core and cladding layers is done by CMP, producing an optically smooth, polished surface. In addition, because the optical waveguides of the invention are formed in a silicon wafer rather than on it, no etching of the core material layer is required. Another advantage is that because the optical waveguide is embedded in a silicon or other wafer, alignment of the waveguide with other devices, particularly optical fibers, is much easier. Optical fibers can be laid in a trench formed in the silicon substrate surface, which can be readily etched and aligned with the waveguide.

The waveguides can also be integrated vertically to other devices formed in the silicon substrate prior to forming the waveguides of the invention. Furthermore, although the present invention has been described in terms of particular substrates and layers, the invention is not meant to be limited to the details set forth herein.

Thus, while the foregoing is directed to embodiments of the present invention, other and further embodiments of the invention may be devised without departing from the basic scope thereof, and the scope thereof is determined by the claims that follow.

1. A method of making an optical waveguide, comprising:
providing a substrate comprising a semiconductor layer disposed on a first insulating layer;
forming a hard mask on the semiconductor layer;
etching an opening in the semiconductor layer to expose a portion of the first insulating layer using the hard mask;
depositing a core material on the first insulating layer to fill the opening;
planarizing the core material;
removing the hard mask; and
depositing a top cladding layer over the core material.

2. The method of claim 1, wherein the semiconductor layer comprises silicon.

3. The method of claim 1, wherein the substrate further comprises a second insulating layer having the first insulating layer disposed thereon.

4. The method of claim 1, wherein the first insulating layer is comprised of at least one of glass or silicon oxide.

5. The method of claim 1, wherein the hard mask further comprises:
a silicon oxide layer formed over a silicon nitride layer.

6. The method of claim 1, wherein the core material contacts the semiconductor layer along a sidewall of the opening.

7. The method of claim 1, further comprising:
conformally depositing a bottom cladding layer in the opening, the bottom cladding layer having a different refractive index than the core material.

8. The method of claim 7, wherein the bottom cladding layer is silicon oxide.

9. The method of claim 7, wherein the step of planarizing further comprises: removing a portion of the bottom cladding layer.

10. The method of claim 1, wherein the step of providing a substrate further comprises:
providing a substrate having integrated circuit features at least partially formed therein.

11. A method of making an optical waveguide, comprising:
providing a substrate comprising a semiconductor layer disposed on a first insulating layer;
depositing a silicon oxide layer over a silicon nitride layer on the semiconductor layer;
depositing a masking layer on the silicon oxide layer;
masking and patterning an opening in the masking layer;
etching through the silicon oxide and silicon nitride layers to form a hard mask;
etching an opening in the semiconductor layer to expose a portion of the first insulating layer;
depositing a core material on the first insulating layer to fill the opening;
planarizing the core material;
removing the silicon oxide layer and the silicon nitride layer; and
depositing a top cladding layer having a different refractive index than the core material.

12. The method of claim 11, wherein the semiconductor layer comprises silicon.

13. The method of claim 11, wherein the substrate further comprises a second insulating layer having the first insulating layer disposed thereon.

14. The method of claim 11, wherein the first insulating layer is comprised of at least one of glass or silicon oxide.

15. The method of claim 11, wherein the core material contacts the semiconductor layer along a sidewall of the opening.

16. The method of claim 11, wherein the step of providing a substrate further comprises:
providing a substrate having integrated circuit features at least partially formed therein.
